(19) United States
(12) Patent Application Publication
(10) Pub. No.: US 2013/0166218 A1
(43) Pub. Date: Jun. 27, 2013

(54) Methods And Systems For Sequence Alignment Computation

(71) Applicant: The Board of Trustees of the University of Illinois, Urbana, IL (US)

(72) Inventors: Reza Farivar, Urbana, IL (US); Shivaram Venkataraman, Berkeley, CA (US); Harshit Kharbanda, Urbana, IL (US); Roy H. Campbell, Champaign, IL (US)

(73) Assignee: The Board of Trustees of the University of Illinois, Urbana, IL (US)

(21) Appl. No.: 13/724,280

(22) Filed: Dec. 21, 2012

Related U.S. Application Data
(60) Provisional application No. 61/578,417, filed on Dec. 21, 2011.

(51) Int. Cl. G06F 19/16

(52) U.S. Cl. CPC G06F 19/16
USPC 702/19

(57) ABSTRACT

A system utilizes a Single Instruction Multiple Data (SIMD) processor to efficiently determine, in parallel, the optimal global alignment for multiple input sequence pairs. The system may partition a score matrix generated for the input sequence pair into multiple sectors. While determining the cell content for each of the cells in the score matrix, the system may selectively retain computed cell contents for upper and left boundary cells of the partitioned sectors. During a traceback process, the system may retrieve the retained boundary cells for a current sector and recompute the cell contents for the current sector. Then, the system may determine the traceback path for the current sector. The system may continue to process sectors one at a time until the traceback path for the score matrix, and accordingly the optimal global alignment for the input sequence pair, is determined.

### CROSS REFERENCE TO RELATED APPLICATIONS

This application claims the benefit of and incorporates by reference U.S. Provisional Patent Application Ser. No. 61/578,417, filed on Dec. 21, 2011, and titled “Methods For Fast Edit Distance Computation.”

### BACKGROUND OF THE INVENTION

1. Field of the Invention

This disclosure relates to computing a sequence alignment. This disclosure also relates to computing a sequence alignment using a single instruction multiple data (SIMD) processor.

2. Description of Related Art

Rapid advances in technology have resulted in computing devices with continually increasing processing capability, speed, and efficiency. Modern computing devices can process immense amounts of data, exploiting multiple levels of parallelism to increase the throughput and processing rate. As the impact of computation locality increases in modern distributed clusters of multi-core processors and many-core accelerators, there is an increasing incentive to process data more efficiently.

### BRIEF DESCRIPTION OF THE DRAWINGS

The innovation may be better understood with reference to the following drawings and description. In the figures, like reference numerals designate corresponding parts throughout the different views.

FIG. 1 shows an example of a system for determining the global alignment of sequence pairs.

FIG. 2 shows an example of a score matrix partitioned by the alignment circuitry.

FIG. 3 shows an example of a partitioned score matrix.

FIG. 4 shows an example score calculations for a score matrix.

FIG. 5 shows an example of processing a current sector in a partitioned score matrix.

FIG. 6 shows an example of processing a current sector in a partitioned score matrix

FIG. 7 shows an example of an optimal alignment determined from a partitioned score matrix.

FIG. 8 shows an example of a system for performing multiple pairwise alignment computations in parallel.

FIG. 9 shows an example of logic that may be implemented in hardware, software, or both.

### DETAILED DESCRIPTION

This disclosure relates to methods, systems, and devices useful for determining the edit distance and/or alignment of two sequences. A sequence may refer to a string of characters, symbols, or any other representation of information, including as examples a character string (e.g., a word), a deoxyribonucleic acid (DNA) or ribonucleic acid (RNA) sequence, and more. Global alignment may refer to the alignment for the entire length of two sequences. One method for computing the global alignment of a sequence pair is the Needleman-Wunsch algorithm, as described in S. B. Needleman and C. D. Wunsch, “A General Method Application to the Search for Similarities in the Amino Acid Sequence of Two Proteins,” Journal of Molecular Biology, 48(3):443-453, March 1970, which is incorporated herein by reference in its entirety.

A global alignment for a sequence pair may include gaps in none, one, or both of the two sequences. A global alignment “score” may be determined for a particular alignment based on a predetermined gap penalty as well as penalties for changing between character values, e.g., as specified through a similarity matrix. Moreover, matching characters in an alignment may result in a bonus, e.g., in contrast to the penalty for changing characters or gaps. The optimal global alignment may refer to alignment between two sequences with the best, e.g., highest, global alignment score as determined according to the predetermined gap penalty and similarity matrix. As one example, the optimal global alignment may be the alignment between the two sequences requiring the fewest operations to transform a first sequence into a second sequence. Examples of operations may include inserting a character or deleting a character (e.g., thus incurring a corresponding gap penalty) or substituting one character for another (e.g., incurring an associated penalty based on the particular character transformation). The gap penalty and/or similarity matrix may vary depending on a particular context or application in which the global alignment determination is being determined.

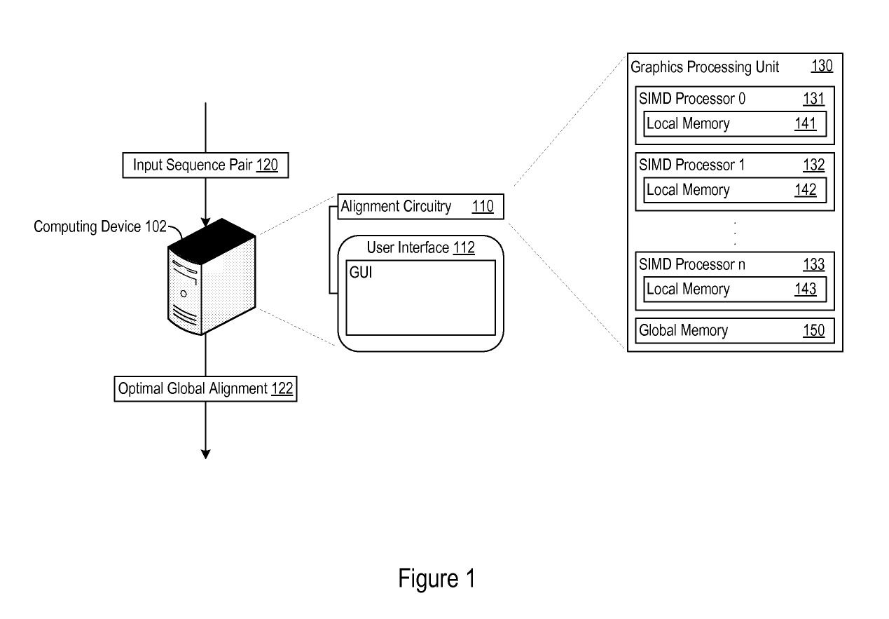

FIG. 1 shows an example of a system 100 for determining the global alignment of sequence pairs. The system 100 shown in FIG. 1 includes the computing device 102, which may take any number of forms including any number or number of computers, laptops, servers, mobile devices, or other electronic processing devices. The computing device 102 includes alignment circuitry 110 for determining the alignment of one or more sequence pairs. Optionally, the computing device 102 may include a user interface 112 for receiving input values and parameters and/or presenting the results of a global alignment determination. The user interface 112 may include, for example, a command line interface (CLI), a graphical user interface (GUI), or both.

The alignment circuitry 110 may determine the optimal global alignment for a sequence pair. In that regard, the alignment circuitry 110 may receive one or more input sequence pairs 120. The alignment circuitry 110 may determine, as an output, the optimal global alignment 122 for each respective input sequence pair 120 received by the computing device 102. The alignment circuitry 110 may process multiple input sequence pairs 120, simultaneously and/or in parallel through multiple processing threads. In that regard, the alignment circuitry 110 may simultaneously process input sequence pairs 120 numbering to the hundreds, the thousands, the millions, or more, depending on the processing capability of the alignment circuitry 110. In one variation, the optimal global alignments 122 also include a respective global alignment score associated with the optimal global alignment as determined for a respective sequence pair.

The alignment circuitry 110 may efficiently utilize one or more Single Instruction Multiple Data (SIMD) processors when computing the optimal global alignments 122 for received input sequence pairs 120. An SIMD processor may refer to a processor with multiple processing cores, e.g., processing elements, arithmetic logic units, and more, that perform the same instruction on multiple data sets. A SIMD processor may include hundreds to thousands of processing cores that can each perform the same instruction or instruction on a respective data set. In that regard, a SIMD processor may simultaneously process multiple (e.g., hundreds, thousands, or more) execution threads. A significant portion of a SIMD processor die may be allocated to implement the multiple processing cores, which may result in lesser on-chip memory availability and lesser, e.g., simplified, control logic as compared to a traditional processor architecture, such as a traditional central processing unit (CPU). Memory intensive instruction sets and control flow divergence among the multiple threads executed on the SIMD processor may severely limit the performance of an SIMD processor.

One example of an architecture that employs SIMD processors is a graphical processing unit (GPU). The alignment circuitry 110 shown in FIG. 1 includes the GPU 130. The GPU 130 may include one or more SIMD processors, such as the SIMD processors labeled in FIG. 1 as SIMD processor 0 131, SIMD processor 1 132, and SIMD processor n 133. A SIMD processor in the GPU 130 may be implemented or referenced as a streaming multiprocessor (SM). A SIMD processor may include local, e.g., on-chip, memory accessible by the processing cores of the SIMD processor. The local memory may include a register file and/or shared memory, such as an L1 cache or other physical memory structures. As seen in FIG. 1, the SIMD processors 131-133 include the local memories 141-143 respectively, which may each include any number of registers, a shared memory (e.g., L1 cache), or both. The GPU 130 may also include “off-chip” memory accessible by each of the SIMD processors 131-133, such as the global memory 150. Access to the global memory 150 by one of the SIMD processors 131-133 may consume multiple execution cycles and decrease the processing throughput of the SIMD processors 131-133.

In operation, the alignment circuitry 110 may leverage the parallelism capabilities of the GPU 130 to efficiently determine the optimal global alignments 122 for received input sequence pairs 120. As described in greater detail below, the alignment circuitry 110 may reduce the memory requirements for performing an optimal global alignment determination, which may reduce the number of accesses to the global memory 150 and increase the efficiency of parallel alignment determinations. The alignment circuitry 110 may also reduce, e.g., eliminate, control flow divergences across the multiple alignment determination threads executing on a SIMD processor 131-133 or the GPU 130 to ensure the multiple threads execute the same number of instructions.

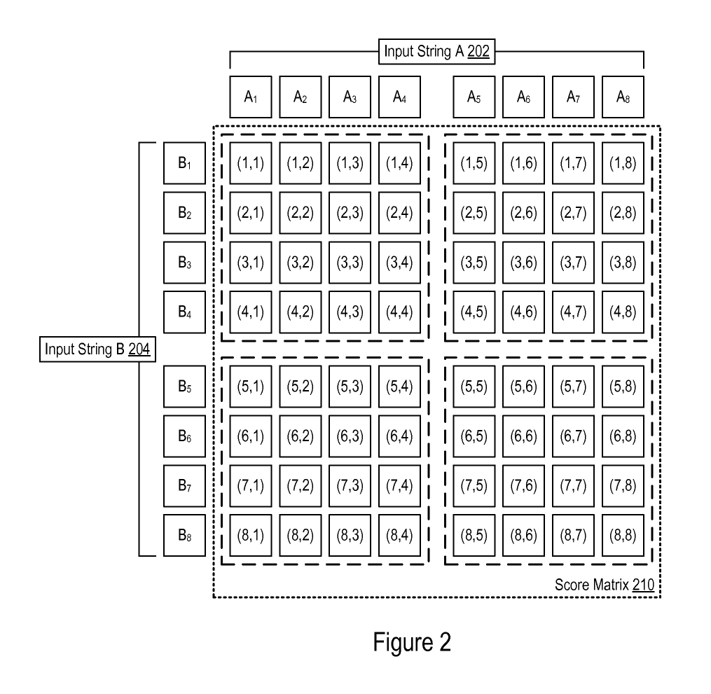

An example of an optimal global alignment determination for an input sequence pair 120 is presented next in FIGS. 2-7. As discussed in greater detail below, the optimal global alignment determination process may include two phases: (i) determining the optimal alignment score for a cells in a score matrix, and (ii) tracing back through a score matrix to obtain the optimal global alignment for the input sequence pair 120. During the first phase, the alignment circuitry 110 may partition a score matrix into any number of sectors and selectively store boundary values for each sector. Then, starting from the bottom right sector of the score matrix, the alignment circuitry 110 recomputes a score matrix for the sector (e.g., a sub-matrix of only the sector) using the retrieved boundary values for the sector. During the second phase, the alignment circuitry 110 performs a traceback process in the current sector to determine a traceback path for the current sector. The alignment circuitry 110 also determines a next sector to process as well as an initial cell in the next sector to start the traceback processing from. The alignment circuitry 110 iteratively processes each “current” sector to determine a traceback path until reaching the last, e.g., upper left, cell of the score matrix. The combined traceback path across all of the processed sectors of the score matrix indicates the optimal global alignment for the input sequence pair 120.

FIG. 2 shows an example 200 of a score matrix partitioned by the alignment circuitry 110 during the first phase of the optimal global alignment determination process. The alignment circuitry 110 may generate a score matrix as a two-dimensional matrix with a width equal to the length of a first input sequence and a height equal to the length of a second input sequence.

FIG. 2 shows an example of a score matrix 210 that the alignment circuitry 110 may generate when determining the optimal global alignment for an input string A 202 and an input string B 204. In this example, input strings A 202 and B 204 each have a length of 8, as they include eight characters, labeled as A₁-A₈ and B₁-B₈ respectively.

The content of each cell (i,j) of the score matrix 210 may include the optimal alignment score for the first i characters of input string A 202 and the first j characters of input string B 204. For example, the cell content of cell (2,3) in the score matrix 210 may include the optimal alignment score for the string {A₁, A₂} and the string {B₁, B₂, B₃}. For a cell (i,j), the optimal alignment score can be determined based on the contents of the cells to the left, top, and top-left of the cell (i,j). In particular, the optimal alignment score of cell (i,j) can be determined according to the following formula:

Max{score(i,j−1)+g,score(i−1,j),score(i−1,j−1)+S[Aᵢ,Bⱼ]}

where g is the gap penalty value and S[Aᵢ,Bⱼ] represents a character change penalty associated with changing character Aᵢ to character Bⱼ or vice versa, e.g., as indicated by a similarity matrix entry specifying character change penalties. The cell contents of cell (i,j) may also indicate which of the three cells (i,j−1), (i−1,j), or (i−1,j−1) resulted in the contents of cell (i,j) from the equation above. That is, the cell contents of cell (i,j) may indicate which of the three cells (i,j−1), (i−1,j), or (i−1,j−1) resulted in the maximum alignment score as determined from the equation above. As one example, the cell contents of cell (i,j) may include a directional indication, such as one of the directions up, left, or diagonal identifying which of the three cells (i,j−1), (i−1,j), or (i−1,j−1) resulted in the optimal alignment score of cell (i,j). Accordingly, the contents of a cell in the score matrix may include an optimal alignment score and a directional indication.

Optionally, the score matrix 210 may include additional top and left boundary cells, such as T number of left boundary cells which can be identified (0,j), ‘i’ number of top boundary cells which can be identified as (i,0), and cell (0,0). The optimal alignment score for each cell (i,0) may be determined as g*i and have a directional indication of left. The optimal alignment score of each cell (j,0) may be determined as g*j and have a directional indication of up. The score of cell (0,0) is 0 and has no directional indication.

The memory requirement for storing an entire score matrix with dimensions ‘m’ by ‘n’ is on the order of O(m*n). When score matrix also includes the additional top and left boundary cells corresponding to column (0,j), row (1,0), and cell (0,0) are stored, the memory requirement for storing the entire score matrix is O((m+1)*(n+1). These memory constraints for storing the entire score matrix may limit the efficiency through which a SIMD processor can process multiple input sequence pairs. To illustrate, a SIMD processor may include, for example, 16 KB of shared on-chip memory (e.g., via an L1 cache). A score matrix generated for two 32-character strings includes 1024 cells, and may require 1024 bytes of memory space, e.g., when each cell's contents can be stored as a byte. In this example, the SIMD processor may be limited to simultaneous execution of 16 global alignment determination threads, as each thread requires 1024 bytes to store its respective score matrix. As another illustration determining the global alignment for two 128-character strings may require 16 KB to store the corresponding score matrix, e.g., the entire shared memory of the SIMD processor. In this case, the SIMD processor can only process a single global alignment determination thread at a time.

To reduce the memory requirements of the optimal global alignment determination, the alignment circuitry 110 may partition the score matrix 210 into any number of two-dimensional sectors. As discussed above, the cell contents for cell (i,j) may be determined using the cell contents of cells (i,j−1), (i−1,j), or (i−1,j−1). Accordingly, the contents of each cell in a sector may be readily computed as long as the content of the sector's top and left boundary cells are accessible. Accordingly, and as understood in conjunction with the description below, the alignment circuitry 110 may forego storing the entire score matrix 210. Also of importance, when performing the traceback process in the second phase of the global alignment determination process, the alignment circuitry 110 may process one sector at a time instead of using the entire score matrix. Sector-by-sector processing reduces the memory requirements for the alignment determination process from O(m*n) to O(sₕ*s_{w}), where sₕ is the sector height and s_{w} is the sector width.

Each sector may include a portion of the cells in the score matrix 210. The alignment circuitry 110 may partition the score matrix 210 into sectors of equal size. In the example shown in FIG. 2, the alignment circuitry 110 partitions the score matrix 210 into four outlined sectors of equal size and dimensions, each with a width and height of four cells. As another variation, the alignment circuitry 110 may partition the score matrix 210 into sectors of differing sizes, and each sector may vary in width, height, or both. The alignment circuitry 110 may partition the score matrix 210 such that each cell only belongs to one sector. In one variation, the alignment circuitry 110 determines sectors as squares, which accordingly minimizes the number of boundary cells to store for the subsequent recomputing of the cell contents of the sector.

The alignment circuitry 110 may determine the size of one or more sectors in the score matrix 210 based on the local memory availability in an SIMD processor, the number of simultaneous execution threads supported by the SIMD processor, or according to any number of additional efficiency or SIMD processing factors. In one implementation, the alignment circuitry 110 may determine the sector sizes of a score matrix 210 such that no sector exceeds a predetermined sector size threshold, e.g., according to number of cells and/or size of a corresponding score matrix associated with the sector. As one variation, the alignment circuitry 110 may determine a sector size, which may include a sector height sₕ and sector width s_{w}, such that the score matrix of the sector does not exceed 64 bytes when the content of a cell can be stored in a single byte, e.g., sₕ*s_{w}≦64. In this example, a SIMD processor with 16 KB of shared local memory may simultaneously store the score matrices of at least 256 sectors, which may be associated with 256 different global alignment determination threads that the SIMD processor may process in parallel.

In one variation, the alignment circuitry 110 may determine a sector size for one or more sectors in the score matrix 210 according to a target number of simultaneous execution threads. In that regard, the alignment circuitry 110 may determine the capacity of the local memory, e.g., register file and/or shared memory, of a SIMD processor and specify a sector size based on a targeted number of simultaneous execution threads. In the example where the SIMD processor includes 16 KB of available shared memory, the alignment circuitry 110 may determine a targeted number of simultaneous execution threads of 1024. Accordingly, the alignment circuitry 110 may determine a sector size such that the score matrix of a sector does not exceed 16 bytes, e.g., dividing the score matrix 210 into 4×4 sectors when cell contents can be stored as a byte.

The alignment circuitry 110 may specify a default sector size, e.g., 64 cells, to use when partitioning a score matrix. The default sector size may be consistent across a particular grouping and/or all of the global alignment determination threads processed by the alignment circuitry 110 or a SIMD processor. As another option, the alignment circuitry 110 may receive one or more sector sizes as specified by a user, e.g., via the user interface 112. The alignment circuitry 110 may alternatively or additionally determine sector size by dividing the score matrix 210 into a predetermined number of horizontal sectors and a predetermined number of vertical sectors, e.g., equally sized or as equally size as possible. Accordingly, the alignment circuitry 110 may determine sector sizes in various ways for various input sequence pairs, and several examples are given below in Table: Sector Configuration, along with additional parameters and memory constraints when an entry of the score matrix can be stored as a byte of data.

TABLE
Sector Configurations

| | | | | | | | Total |
|---|---|---|---|---|---|---|---|
| | | | Score | | Number | Shared | Shared |
| | | | Matrix | Number of | of | Memory | Memory |
| Config. | Sequence | Score | Memory | Horizontal | Vertical | Per | Per |
| ID | Size | Matrix | (KB) | Sectors | Sectors | Thread | Thread |
| A | 30 × 30 | 31 × 31 | 0.938 | 4 | 8 | 32 | 42 |
| B | 30 × 30 | 31 × 31 | 0.938 | 5 | 7 | 35 | 44 |
| C | 36 × 36 | 37 × 37 | 1.337 | 5 | 8 | 40 | 50 |
| D | 36 × 36 | 37 × 37 | 1.337 | 6 | 7 | 42 | 51 |
| E | 75 × 75 | 76 × 76 | 5.641 | 8 | 10 | 80 | 92 |
| F | 75 × 75 | 76 × 76 | 5.641 | 9 | 9 | 81 | 92 |
| G | 75 × 75 | 76 × 76 | 5.641 | 10 | 8 | 80 | 90 |
| H | 75 × 75 | 76 × 76 | 5.641 | 11 | 7 | 77 | 86 |
| I | 100 × 100 | 101 × 101 | 9.962 | 11 | 10 | 110 | 122 |
| J | 100 × 100 | 101 × 101 | 9.962 | 12 | 9 | 108 | 119 |
| K | 100 × 100 | 101 × 101 | 9.962 | 13 | 8 | 104 | 114 |
| L | 100 × 100 | 101 × 101 | 9.962 | 15 | 7 | 105 | 114 |
| M | 127 × 127 | 128 × 128 | 16 | 14 | 10 | 130 | 142 |
| N | 127 × 127 | 128 × 128 | 16 | 15 | 9 | 135 | 146 |
| O | 127 × 127 | 128 × 128 | 16 | 17 | 8 | 128 | 138 |
| P | 127 × 127 | 128 × 128 | 16 | 19 | 7 | 133 | 142 |

In the Table: Sector Configurations above, several exemplary configurations are listed with a respective configuration ID listed in the “Config. ID” column. The “Sequence Size” column indicates the length of the sequences being aligned by the alignment circuitry 110. In this table, sequences of equal length are aligned, though the alignment determination may also be applied to sequences of different length as well. Each row contains a sector size configuration with varying horizontal and vertical vector configurations. The “Shared Memory Per Thread” column indicates memory requirements (KB) to process a single thread using the row configuration during the second phase of the sequence alignment determination. This value can be calculated as INT(Sequence Size of First Sequence/Number of Horizontal Sectors+1)*INT(Sequence Size of Second Sequence/Number of Vertical Sectors+1). The “Total Shared Memory Per Thread” column further includes the memory requirement for an O(m+2) reduced memory structure used during the first phase of the sequence alignment determination and discussed in greater detail below, where ‘m’ is the length of the sequence along the top of the score matrix 210, e.g., input string A 202 in FIG. 2 with a length of 8 characters.

Table: Sector Configuration Tesla below shows exemplary processing statistics using the configurations in Table: Sector Configurations above and for the Nvidia® Tesla GPU architecture with 1.x Compute Capability (e.g., 1.3) and 16 KB of shared memory.

TABLE
Sector Configuration Tesla

| | Score Matrix | Number of | Number of | Tesla | |
|---|---|---|---|---|---|
| Config. | Memory | Horizontal | Vertical | Threads | Tesla |
| ID | (KB) | Sectors | Sectors | Per Block | Occupancy |
| A | 0.938 | 4 | 8 | 256 | 25.00% |
| B | 0.938 | 5 | 7 | 256 | 25.00% |
| C | 1.337 | 5 | 8 | 256 | 25.00% |
| D | 1.337 | 6 | 7 | 256 | 25.00% |
| E | 5.641 | 8 | 10 | 160 | 16.00% |
| F | 5.641 | 9 | 9 | 160 | 16.00% |
| G | 5.641 | 10 | 8 | 160 | 16.00% |
| H | 5.641 | 11 | 7 | 160 | 16.00% |
| I | 9.962 | 11 | 10 | 128 | 13.00% |
| J | 9.962 | 12 | 9 | 128 | 13.00% |
| K | 9.962 | 13 | 8 | 128 | 13.00% |
| L | 9.962 | 15 | 7 | 128 | 13.00% |
| M | 16 | 14 | 10 | 96 | 9.00% |
| N | 16 | 15 | 9 | 96 | 9.00% |
| O | 16 | 17 | 8 | 96 | 9.00% |
| P | 16 | 19 | 7 | 96 | 9.00% |

In Table: Sector Configuration Tesla above, the number of threads per block may be extracted using GPU utilization tools, e.g., as provided by Nvidia®. Similarly, the occupancy value can be extracted from GPU utilization tools, taking into account the number of threads per block of the GPU and other GPU parameters. The alignment circuitry 110 may perform any of the calculations and determinations in the Tables above and below. As one example, the alignment circuitry 110 may select the sector configuration and/or determine a sector size that results in the highest Occupancy, e.g., of a particular GPU. As another example, the alignment circuitry 110 may select a sector configuration and/or determine a sector size with a GPU Occupancy that exceeds a predetermined threshold. Table: Sector Configuration Fermi below shows exemplary processing statistics using the configurations in Table: Sector Configurations above and for the Nvidia® Fermi GPU architecture with 2.x Compute Capability (e.g., 2.0) and 48 KB of shared memory.

TABLE
Sector Configuration Fermi

| | Score Matrix | Number of | Number of | Fermi | |
|---|---|---|---|---|---|
| Config. | Memory | Horizontal | Vertical | Threads | Fermi |
| ID | (KB) | Sectors | Sectors | Per Block | Occupancy |
| A | 0.938 | 4 | 8 | 1024 | 50.00% |
| B | 0.938 | 5 | 7 | 1024 | 50.00% |
| C | 1.337 | 5 | 8 | 992 | 48.00% |
| D | 1.337 | 6 | 7 | 992 | 48.00% |
| E | 5.641 | 8 | 10 | 534 | 27.00% |
| F | 5.641 | 9 | 9 | 534 | 27.00% |
| G | 5.641 | 10 | 8 | 534 | 27.00% |
| H | 5.641 | 11 | 7 | 576 | 28.00% |
| I | 9.962 | 11 | 10 | 416 | 20.00% |
| J | 9.962 | 12 | 9 | 416 | 20.00% |
| K | 9.962 | 13 | 8 | 448 | 22.00% |
| L | 9.962 | 15 | 7 | 448 | 22.00% |
| M | 16 | 14 | 10 | 352 | 17.00% |
| N | 16 | 15 | 9 | 352 | 17.00% |
| O | 16 | 17 | 8 | 352 | 17.00% |
| P | 16 | 19 | 7 | 352 | 17.00% |

The exemplary sector configurations, GPU parameters, and GPU statistics discussed above are illustrative, and the alignment circuitry 110 may determine any number of sector configurations and sizes according to any number of factors and/or criteria.

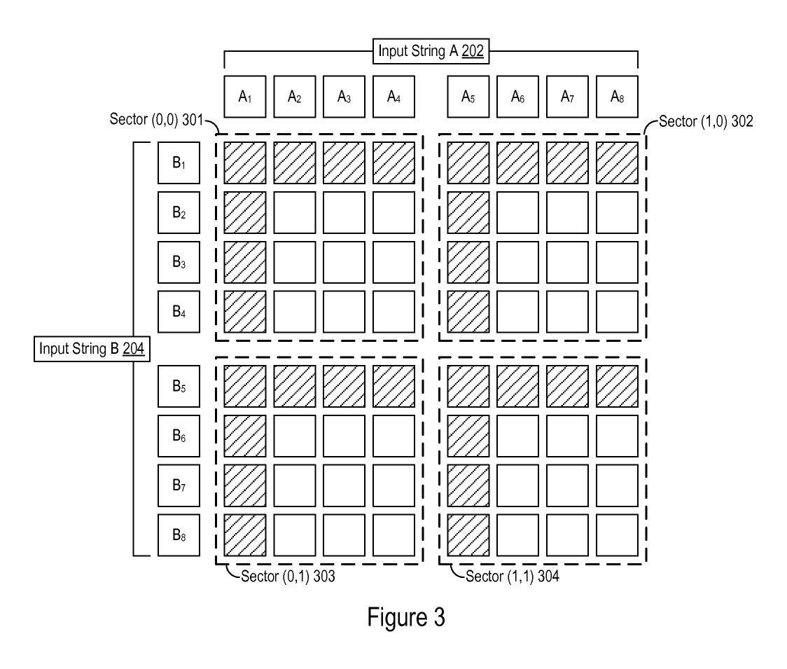

FIG. 3 shows an example 300 of a partitioned score matrix, such as the score matrix 210. In FIG. 3, the alignment circuitry 110 partitions the score matrix 210 for input strings A 202 and B 204 into the four sectors labeled as sector (0,0) 301, sector (1,0) 302, sector (0,1) 303, and sector (1,1) 304. Each of the sectors 301-304 have a height and width of four cells. After partitioning the score matrix 210 into sectors, the alignment circuitry 110 may determine the cell content for each of the cells in the score matrix 210, e.g., according to the gap penalty, similarity matrix, and cell content formula described above.

The alignment circuitry 110 may selectively retain determined cell contents after the first phase while discarding the determined cell content that are not selectively retained. The alignment circuitry 110 may utilize the selectively retained cell contents, if needed, in the subsequent traceback process during the second phase. Specifically, the alignment circuitry 110 may store the determined cell content when the cell corresponds to a top and/or left boundary cell for a sector, such as the grayed cells in FIG. 3. For example, the alignment circuitry 110 may retain the computed cell content of cells (1,1), (2,1), (3,1), (4,1), (1,2), (1,3), and (1,4), which correspond to the top and left boundary cells of sector (0,0) 301. The alignment circuitry 110 may forego retaining the determined cell content when the cell does not correspond to a top and/or left boundary cell of a sector, such as cells (2,2), (3,2), (4,2), (2,3), (3,3), (4,3), (2,4), (3,4), and (4,4) of sector (0,0) 301. However, as described below, the alignment circuitry 110 may temporarily store the cell contents of non-sector boundary cells to compute the cell contents subsequent cells in the score matrix 210 during the first phase. In a consistent manner, the alignment circuitry 110 may selectively retain the determined cell contents from sectors 302-304 according to whether the cell corresponds to a top and/or left boundary cell of sectors 302-304.

The alignment circuitry 110 may retain, e.g., store the sector boundary cell content for each partitioned sector in various locations. The alignment circuitry 110 may determine a storage location based on the size of the input sequence, e.g., according to whether the input sequence length exceeds a predetermined threshold. In one implementation, the alignment circuitry 110 stores the boundary cell content in the global memory 150, e.g., when an input sequence length exceeds the predetermined threshold. When the traceback process is performed, the boundary cell content of a particular sector may be loaded depending on the traceback path determined from a previously processed sector. However varying traceback paths may result in non-coalesced memory accesses. To address the potential for non-coalesced memory accesses, the alignment circuitry 110 may read all of the stored boundary cell content for each of the sectors, e.g., 301-304, into a first portion of a local memory. During this process, the alignment circuitry 110 may identify the boundary cell content of the current sector being processed, and store the identified boundary cell content corresponding to the top and/or left boundary cells of the current sector in a second portion of the local memory. Accordingly, the alignment circuitry 110 may prevent code flow divergence for memory caused by iterative traceback path determinations and ensure coalesced memory accesses to the global memory 150.

In one variation, the alignment circuitry 110 stores the determined boundary cell content in registers of a SIMD processor. Each processing cores in the SIMD processor may include an associate register file. As one example, the alignment circuitry 110 may store the sector boundary cell content in registers when an input sequence length is less than a predetermined threshold. As registers support specific variable values (as opposed to an array implementation), the content access logic 110 may read all of the stored boundary cell content into a first portion of a shared memory and identify and store boundary cell content of a current sector in a second portion of the shared memory, e.g., as described above.

Selectively retaining the cell content of sector boundary cells may be a purpose of the first phase of the global alignment determination process. That is, during the first phase, the alignment circuitry 110 may compute the cell contents for each cell in the score matrix 210, but selectively retain the computed cell contents for sector top and left boundary cells. Thus, during the first phase, the alignment circuitry 110 may compute cell content of the score matrix 210 using a reduced memory space. In other words, the alignment circuitry 110 need not utilize a memory space of O(m*n) to store the entire score matrix 210 even though the alignment circuitry determines the cell content of each cell in the score matrix 210. In particular, the content access logic 110 may use a reduced memory space with a capacity on the order of O(m+2) to perform the cell content computations during the first phase of the global alignment determination process, where m is the width of the score matrix 210.

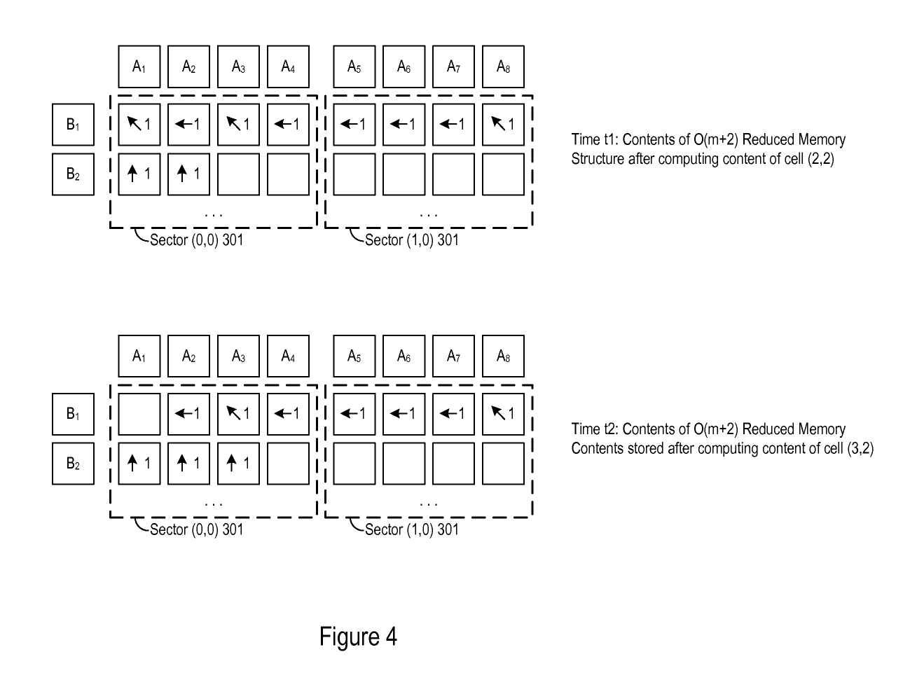

FIG. 4 shows an example 400 of cell content determinations for a score matrix. The alignment circuitry 110 may use a reduced memory structure of size O(m+2) during the first phase, e.g., during a first pass through the score matrix 210. In the example 400, the alignment circuitry 110 may be in the process of determining cell content in the score matrix 210 and selectively retaining determined cell content for later use in a traceback phase. As discussed above, to determine the cell content of a cell (i,j), the alignment circuitry 110 may require access to the cell content of cells (i,j−1), (i−1,j), and (i−1,j−1). Thus, the alignment circuitry 110 may temporarily store the content of at least two cells in a previous row until determining the content of each cell in a current row.

As the alignment circuitry 110 processes cell j in a current row, the alignment circuitry 110 may access the contents of cells (i−1,j−1) and (i−1,j) of the previous row, but no longer require the contents of cell(s) (i−1,1) through (i−1,j−2). Thus, the alignment circuitry 110 may overwrite the content of cell (i-1,j2) in the O(m+2) reduced memory structure with the determined cell content of cell (i,j). The alignment circuitry 110 may forego storing and/or overwriting the content of cells corresponding the column (0,j) or (i,0) as the content of these cells can be readily determined based on the gap penalty and without reference to other cells in the score matrix 210.

As an illustration, FIG. 4 shows an example of the contents of the O(m+2) reduced memory structure at various points during the first phase of the global alignment determination process. In this example, the score matrix 210 has a width of 8 cells, and as such, the O(m+2) reduced memory structure may have a capacity of m+2 bytes, e.g., 10 bytes. Prior to time t1, the alignment circuitry 110 may determine the cell content of cell (2,2) by accessing the contents of cells (1,2) of the current row and cells (1,1) and (2,1) of the previous row. In FIG. 4, the alignment circuitry 110 determines the optimal alignment score of cell (2,2) as the value 1 and a directional indication of “up.” As cell (2,2) does not correspond to a top or left boundary cell of sector (0,0) 301, the alignment circuitry 110 may forego retaining the content of cell (2,2) apart from temporarily storing the content of cell (2,2) in the O(m+2) memory structure. Thus, the contents of the O(m+2) memory structure after time t1 include the contents of the following cells: {(1,1), (2,1), (3,1), (4,1), (5,1), (6,1), (7,1), (8,1), (1,2), (2,2)}. In FIG. 4, the contents of the O(m+2) reduced memory structure are shown as the populated cell contents, and blank cells are not stored in the O(m+2) reduced memory structure.

Prior to time t2, the alignment circuitry 110 determines the cell content for cell (3,2) by accessing the contents of cell (2,2) of the current row and cell (1,2) and (1,3) of the previous row. As the contents of cell (1,1) are no longer required during the first phase, the alignment circuitry 110 may overwrite the content of cell (1,1) in the O(m+2) memory structure with the determined content of cell (3,2). Accordingly, the contents of the O(m+2) memory structure after time t2 include the contents of the following cells: {(2,1), (3,1), (4,1), (5,1), (6,1), (7,1), (8,1), (1,2), (2,2), (3,2)}. Even though the alignment circuitry 110 overwrites the content of cell (1,1) after time t2, the alignment circuitry 110 may have previously retained the cell content of cell (1,1) upon identifying that cell (1,1) corresponds to a boundary cell of sector (0,0) 301, e.g., in the global memory 150 or in a register of an associated processor core in the SIMD processor.

In different variations, the alignment circuitry 110 may perform the first phase of the global alignment determination using a reduced memory structure of a different size. For example, the alignment circuitry 110 may store two rows of data a time, thus using an O(2*m) reduced memory structure. Additional variations are possible to reduce the memory requirement from the O(m*n) requirement for storing the entire score matrix 210 during the first phase.

After completing the first phase of the global alignment determination process, e.g., after the first computing pass through a score matrix 210, the alignment circuitry 110 may have stored boundary cell content for each of the partitioned sectors. In that regard, the alignment circuitry 110 may recompute the score matrix of a particular sector by retrieving the stored boundary cell content for the particular sector. At this point, the alignment circuitry 110 may begin the second phase and perform the traceback process to determine the optimal global alignment of an input sequence pair.

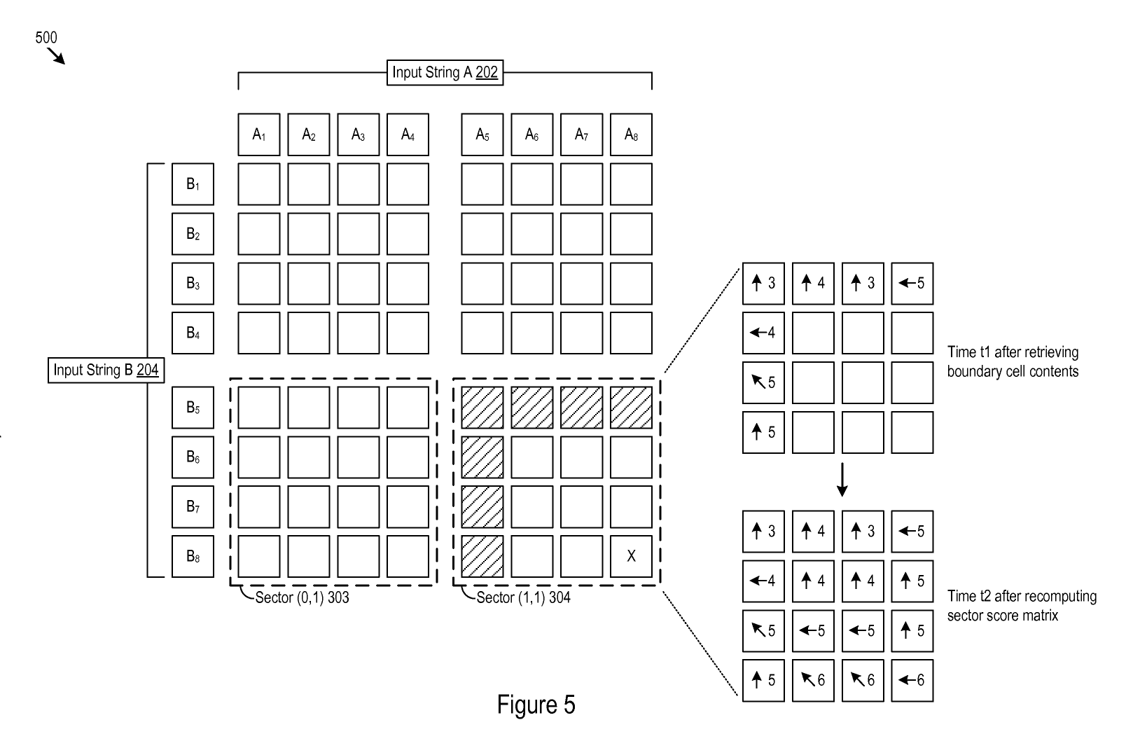

FIG. 5 shows an example 500 of processing a current sector in a partitioned score matrix. The alignment circuitry 110 may process sectors in the partitioned score matrix one at a time during the second phase, e.g., the traceback process, of the global alignment determination process. During the traceback process of a particular alignment determination thread, the alignment circuitry 110 may process one sector at a time until the traceback process reaches cell (0,0) of the score matrix 210. The alignment circuitry 110 starts the traceback process by processing the partitioned sector that includes the bottom right cell of the score matrix 210. In the example shown in FIG. 5, the alignment circuitry 110 identifies sector (1,1) 304 as the first “current” sector for processing at the start of the traceback process.

In processing a current sector, the alignment circuitry 110 recomputes a score matrix for the current sector, e.g., a sub-matrix of the score matrix 210 that includes the cells of the current sector. In that regard, the alignment circuitry 110 may retrieve the stored boundary cell contents as determined and retained in the first phase discussed above. For the sector (1,1) 304, the alignment circuitry 110 retrieves the cell contents of the top and left boundary cells of sector (1,1) 304, which includes the grayed cells (5,5), (6,5), (7,5), (8,5), (5,6), (5,7), and (5,8). Accordingly, as seen in FIG. 5, the alignment circuitry 110 retrieves the contents of boundary cells at time t1 and computes the score matrix of the current sector (e.g., sector (1,1) 304 in this example) at time t2. After computing the score matrix for a current sector, the alignment circuitry 110 may determine the traceback path for the current sector.

The alignment circuitry 110 may start with an initial cell in the current sector and determine a traceback path according to the directional indication of one or more cells in the current sector. For the initial sector in the traceback process, the alignment circuitry 110 identifies the bottom right cell of the score matrix 210 as the initial cell. In the example shown in FIG. 5, the alignment circuitry 110 identifies cell (8,8) as the initial cell of the current sector, which includes a directional indication of “left.” By following the directional indication of cell (8,8), the alignment circuitry 110 may identify cell (7,8) as the next cell in the traceback path. In a similar way, the alignment circuitry 110 identifies the remaining cells that form the traceback path for the current sector, e.g., sector (1,1) 304. In the example in FIG. 5, the alignment circuitry 110 determines the traceback path in sector (1,1) 304 as the path from cell (8,8) to (7,8) to (6,7) to (5,7). The alignment circuitry 110 may also identify the traceback path of sector (1,1) 304 in terms of directional indications, e.g., as {left, diagonal, left, diagonal}.

In performing a traceback process for a current sector, the alignment circuitry 110 may determine a next sector and an initial cell in the next sector from which to continue the traceback process. The alignment circuitry 110 may determine the next sector and next initial cell based on the last cell of the traceback path in the current sector. For sector (1,1) 304 in FIG. 5, the last cell of the traceback path is cell (5,7). The directional indication of cell (5,7) is diagonal, which indicates cell (4,6) in sector (0,1) 303. Thus, after processing sector (1,1) 304, the alignment circuitry 110 may identify sector (0,1) 303 as the next sector and cell (4,6) as the initial cell in sector (0,1) 303.

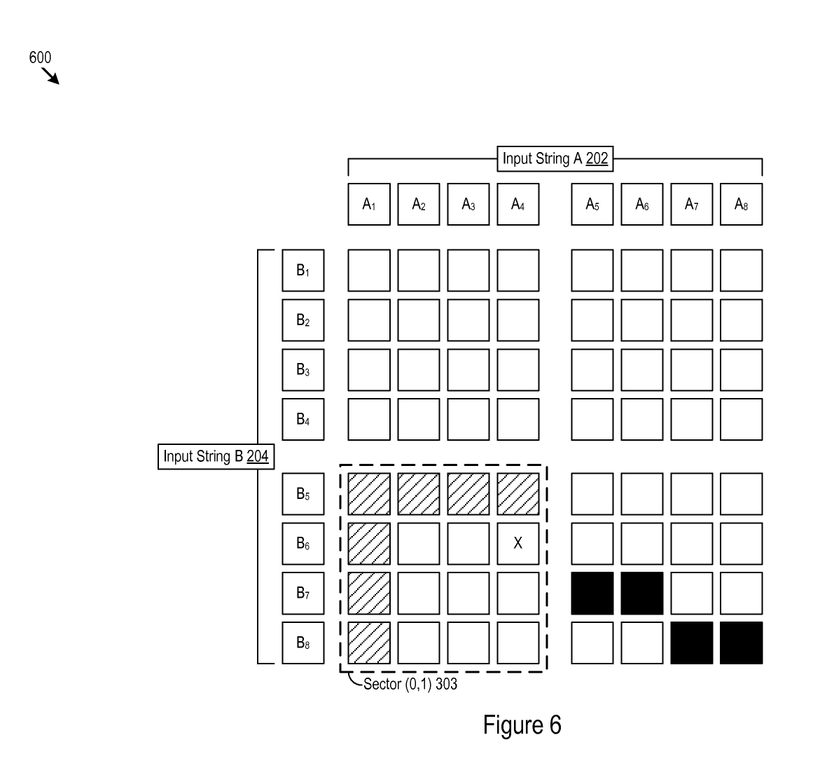

FIG. 6 shows an example 600 of processing a current sector in a partitioned score matrix. In FIG. 6, the alignment circuitry 110 identifies sector (0,1) 303 as the current sector and cell (4,6) as the initial cell to continue the traceback process from. Accordingly, the alignment circuitry 110 may retrieve the boundary cell contents for sector (0,1) 303, including the grayed cells (1,5), (2,5), (3,5), (4,5), (1,6), (1,7), and (1,8). Then, the alignment circuitry 110 may identify the traceback path in sector (0,1) 303 by tracing the directional indication of one or more cells in sector (0,1) 303 starting with the initial cell (4,6), e.g., in a similar way as described above. The alignment circuitry 110 may continue to perform the traceback process for each identified “next sector” until reaching cell (0,0) of the score matrix 210.

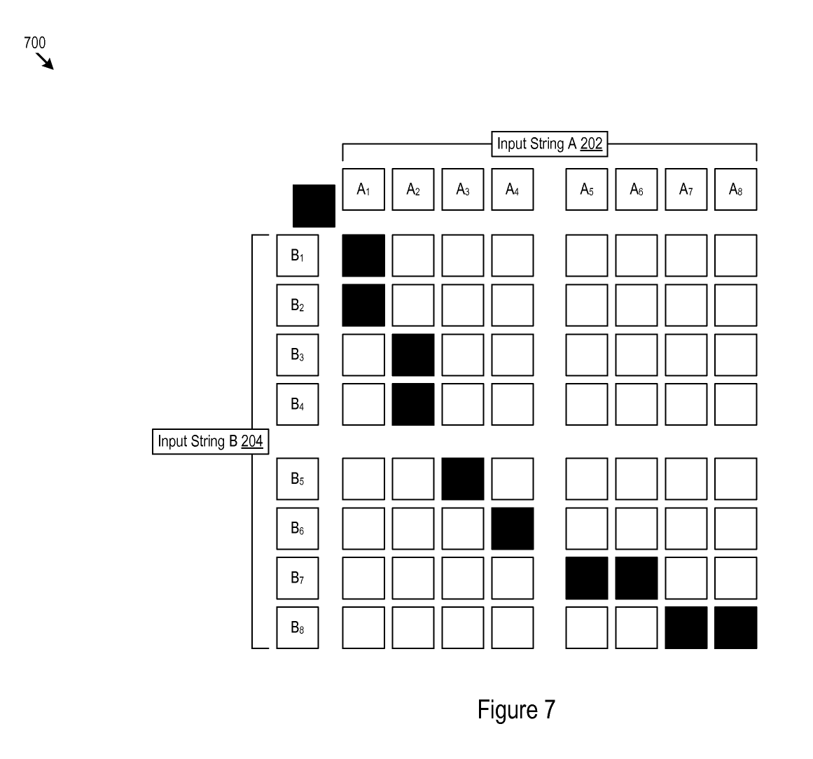

FIG. 7 shows an example 700 of an optimal global alignment determined from a partitioned score matrix. The optimal global alignment for input string A 202 and input string B 204 is indicated by the traceback path determined by the alignment circuitry 110. In FIG. 7, the traceback path is identified by the blackened cells of the score matrix 210 and includes the path from cell (8,8) to (7,8) to (6,7) to (5,7) to (4,6) to (3,5) to (2,4) to (2,3) to (1,2) to (1,1) to (0,0). The traceback path may also be identified in terms of directional indications. Accordingly, the alignment circuitry 110 may identify the traceback path as {left, diagonal, left, diagonal, diagonal, diagonal, up, diagonal, up}.

Each directional indication in the traceback path may correspond to an alignment action performed on the input string A 202 and/or the input string B 204. A “diagonal” value indicates the two sequences are aligned, a “left” value indicates a gap is inserted in the left sequence (e.g., input string B 204), and an “up” value indicates a gap is inserted in the top sequence (e.g., input string A 202). The input strings A 202 and B 204 are aligned backwards. Thus, according to the traceback path shown in FIG. 7, the optimal global alignment for input string A 202 and input string B 204 is:

| | | | | | | | | | |
|---|---|---|---|---|---|---|---|---|---|
| A₁ | — | A₂ | — | A₃ | A₄ | A₅ | A₆ | A₇ | A₈ |
| B₁ | B₂ | B₃ | B₄ | B₅ | B₆ | B₇ | — | B₈ | — |

where “−” represents a gap. Also, the alignment circuitry 110 may identify alignment score of the bottom right cell in the score matrix 210 as the optimal alignment score for the two sequences.

The traceback processing for a sector is inherently data-specific. That is, the number of cells/steps in the traceback path may vary for different sectors. For a sector of width s_{w} and height sₕ, the traceback path for the sector may include as many as s_{w}+sₕ steps, e.g., s_{w} steps leftwards and sₕ steps upwards, and as few as max(s_{w},sₕ) steps, e.g., by including the maximum number of diagonal steps through the sector. Accordingly, when a SIMD processor performs multiple global alignment determinations in parallel, diverging flows may result during the traceback process. That is, in processing different sectors of different threads in parallel, the SIMD processor could perform a different number of instructions for the different threads, thereby resulting in code divergence.

The alignment circuitry 110 may adapt the traceback process such that a predetermined number of instructions are executed for the traceback processing of each sector. The alignment circuitry 110 may adapt the processing such that all threads performing the traceback process perform the same, e.g., maximum, number of iterations for processing of a sector. When a thread processing a current sector for an input sequence pair completes the traceback processing in less than the maximum iterations (e.g., s_{w}+sₕ), the alignment circuitry 110 performs dummy computations. In this way, all parallel global alignment determination threads perform the same amount of instructions, allowing the SIMD processor to avoid divergent flows.

To ensure each thread executes the same predetermined number and/or set of instructions, the alignment circuitry 110 may employ loop maximization. A loop maximization example is presented next. The alignment circuitry 110 may employ a loop maximization technique to transform the following data-dependent pseudo code:

Input a, 0 < a 20
While (a > 0) {

x += func(a);

}

The while loop above may iterate for a variable number of iterations, dependent on the value of ‘a,’ which may vary from thread to thread. The alignment circuitry 110 may transform the above code to remove the while condition, and instead use the following intermediate code:

For (i=0; i<20;i++) {

cond = (a>0)
if (cond)

x += func(a);

}

However, the intermediate code may also suffer from code divergence in that number of instructions performed across different threads inside the conditional block may vary depending on when the value of ‘a’ is no longer greater than 0. In that regard, the threads executing the intermediate code above may still perform a varying number of instructions. Accordingly, the alignment circuitry 110 may further transform the intermediate code into the resulting maximized code:

For (i=0; i<20;i++) {

cond = (a>0);
x += func(a) * cond;

}

In the C programming language, the conditions may take on an integer value. Accordingly, when the value ‘a’ is no longer greater than 0, the alignment circuitry 110 may continue to perform the operation “x+=func(a)*cond;” though with no effect. In this way, the alignment circuitry 110 may ensure each thread executed by a SIMD processor performs the same number and set of instructions, for example during sector traceback processing.

The loop maximization processes described above may increase the number of instructions performed by threads in the SIMD processor, e.g., increasing the run-time computation time/amount from average to worst case. However, the increased computation amount allows the alignment circuitry 110 to eliminate divergent flows in the SIMD processor, which may increase the efficiency and exploited parallelism by a significant factor.

The alignment circuitry 110 may utilize GPU specific mechanism to reduce the number of executed instructions for a data-specific process while continuing to ensure each of the threads execute the same number and/or set of instructions. Specifically, the GPU 130 may include an instruction that evaluates a condition simultaneously in all the threads of a thread group, e.g., a warp. An example of such an instruction is the “_all(condition)” function provided by Nvidia™ GPUs of compute capability 1.3 or higher. Accordingly, the alignment circuitry 110 may adapt the sector processing instructions similar to the following code:

For (i=0; i<20;i++) {

cond = (a>0);
x += func(a) * cond;
if _{——}all(!cond) break( );

}

Thus, when each of the threads in a thread group share the same cond value of TRUE, then the alignment circuitry 110 can proceed to a subsequent set of instructions, e.g., traceback processing of a next sector.

In a similar way, the alignment circuitry 110 may address flow divergences that may result from processing a varying number of sectors. To illustrate, the alignment circuitry 110 may partition the score matrix 210 into four equal sectors of equal width and height, e.g., similar to FIG. 3 described above. Depending on the traceback path, the alignment circuitry 110 may process a total two sectors during the second phase, e.g., when the traceback path includes cell (5,5) and the directional indication of cell (5,5) is diagonal, resulting in a next sector (0,0) 301. The alignment circuitry 110 may also process a total of three sectors during the second phase, e.g., any traceback processing that includes processing of sector (0,1) 303 or sector (1,0) 302. Thus, to avoid divergent code flows based on the varying number of sectors processed during the traceback process, the alignment circuitry 110 may retrieve and process a predetermined number of sectors, e.g., the worst case number for a score matrix 210. When a particular global alignment determination thread reaches cell (0,0) during the traceback process prior to processing the predetermined number of sectors, the alignment circuitry 110 may perform dummy operations. The alignment circuitry 110 may also similarly employ GPU mechanism to potentially reduce the number of processed sectors.

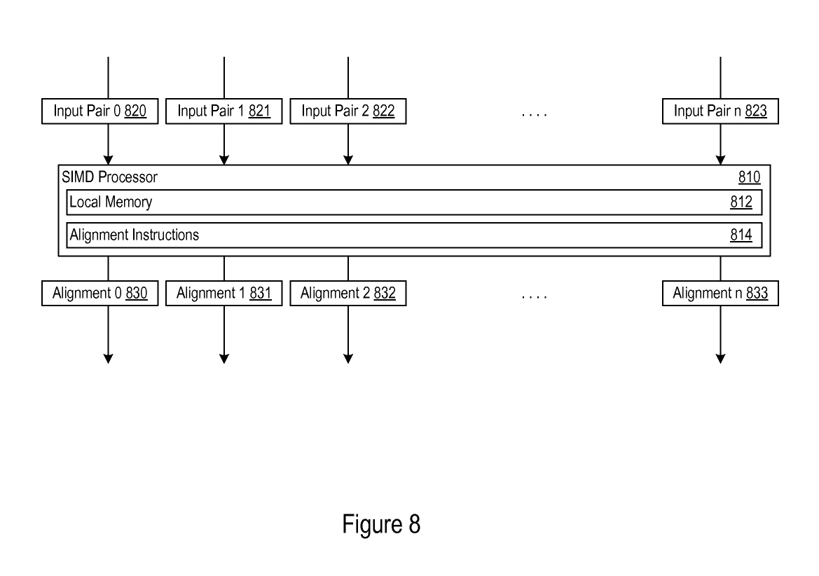

FIG. 8 shows an example of a system 800 for performing multiple optimal global alignment computations in parallel. The system 800 includes the SIMD processor 810 with a local memory 812. The SIMD processor 810 may also include, for example, alignment instructions 814 which may be include the instruction set for computing a global alignment determination. The alignment instructions 814 may be stored on any memory space in the SIMD processor 810. The SIMD processor 810 receives multiple input pairs, including those labeled as input pair 0 820, input pair 1 821, input pair 2 822, and input pair n 823. The SIMD processor 810 processed the received input pairs in parallel and determines the optimal global alignment for each pair, including alignment 0 830, alignment 1 831, alignment 2 832, and alignment n 833. The system 800 may employ any of the methods and processes discussed above, allowing the SIMD processor 810 to simultaneously and efficiently determine the optimal global alignment for multiple, e.g., hundreds to thousands, of input sequence pairs.

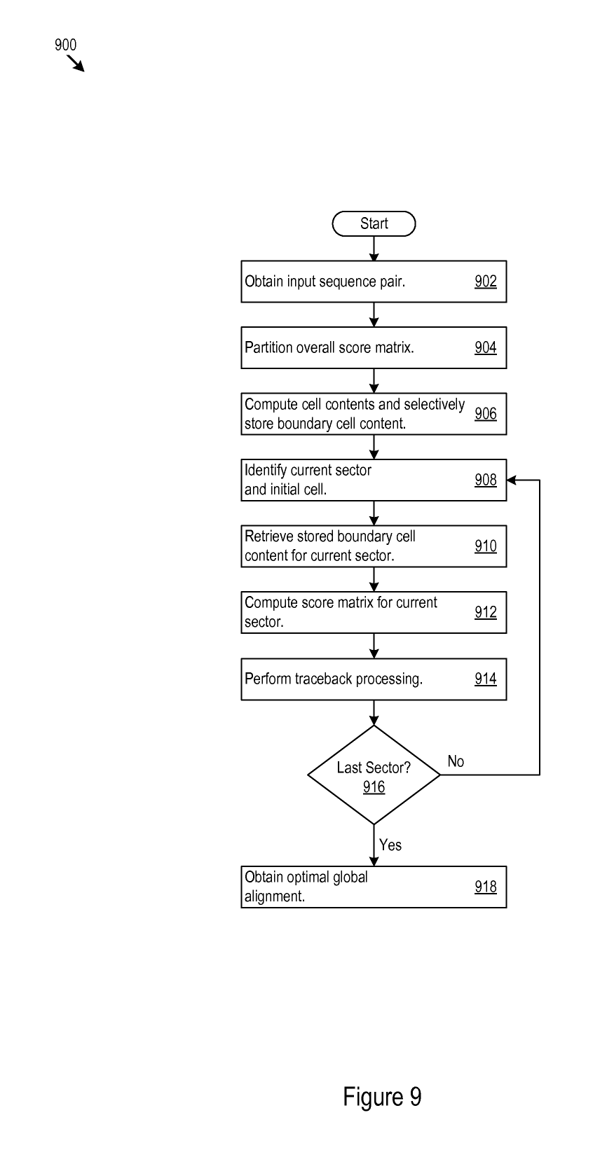

FIG. 9 shows an example of logic 900 that may be implemented in hardware, software, or both. For instance, the alignment circuitry 110 may implement the logic 900 as software.

The alignment circuitry 110 may obtain an input sequence pair (902) as well as any computation values, e.g., gap penalty and/or similarity matrix. Using the input sequence pair, the alignment circuitry 110 may produce an overall score matrix for the sequence pair as described above.

The alignment circuitry 110 may partition the overall score matrix into multiple sectors (904). In that regard, the alignment circuitry 110 may determine a sector size for one or more the multiple sectors, e.g., based on local memory availability or a supported multi-thread execution capability, e.g. of the GPU 130 or the SIMD processor 810. The alignment circuitry 110 may also specify a targeted simultaneous thread number and determine sector size for one or more sectors for one or more execution threads accordingly. The alignment circuitry 110 may determine a common sector size across one or more global alignment determination threads processed by the GPU 130 and/or a SIMD processor 810. As another example, the alignment circuitry 110 may determine the sector size based on sector size criteria, e.g., a predetermined maximum sector size.

Continuing, the alignment circuitry 110 may perform a first pass through the score matrix, computing cell contents for each cell in the score matrix (906). The alignment circuitry 110 may selectively store boundary cell content corresponding to a top and/or left boundary of partitioned sector in the score matrix for potential later use in the traceback process. The alignment circuitry 110 may also temporarily store computed cell contents of boundary and non-boundary cells in a memory structure during the first pass. As discussed above, the memory structure may be temporary and have O(m+2) capacity.

Upon completing the first pass and storing the boundary cell contents for each partitioned sector, the alignment circuitry 110 may perform a second, e.g., traceback pass through the score matrix. In that regard, the alignment circuitry 110 may identify a current sector and initial cell (908). At the start of the traceback process, the alignment circuitry 110 identifies the bottom and right-most cell of the overall score matrix as the initial cell and the sector that includes the initial cell as the current sector.

In processing a current sector during the traceback process, the alignment circuitry 110 may retrieve the stored boundary cell content for the current sector (910) and compute the score matrix for the current sector (912). Then, the alignment circuitry 110 may perform traceback processing of the current sector (914), e.g., obtaining a traceback path for the current sector by tracing the directional indication of one or more cells in the current sector.

To prevent code divergence from other threads, the alignment circuitry 110 may continue to execute dummy instructions if the traceback processing completes prior to a predetermined condition, such as reaching a predetermined number of instructions, e.g., worst case run-time, or when a multi-thread condition is satisfied, e.g., _all(cond).

The alignment circuitry 110 may determine the traceback process has completed when the traceback path reaches cell (0,0) of the overall score matrix, e.g., the last sector has been processed (916). When the last sector has not been processed, the alignment circuitry may identify a next sector to process as the “current” sector and an associated initial cell. The alignment circuitry 110 may iteratively perform the traceback process until reaching cell (0,0) of the overall score matrix.

In one embodiment, after reaching cell (0,0), the alignment circuitry 110 may continue to perform dummy instructions, e.g., until a worst-case run time expires based on number of executed instructions or when a multi-thread condition has been satisfied, e.g., _all(cond).

The alignment circuitry 110 may obtain optimal global alignment for the input sequence pair (918), which may be determined using the traceback path.

The sequence pair alignment determination methods and systems described above may be used across a wide range of settings, contexts, applications, and fields. For example, the alignment determination methods and systems described above may be used in domains such as spell checkers, virus scanners, security kernels, optical character recognition, bioinformatics, genome sequence alignment, and many other arenas.

The methods, devices, systems, circuitry, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability described above may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the systems and methods have been described, it will be apparent to those of ordinary skill in the art that many more embodiments and implementations are possible within the scope of the systems and methods. Accordingly, the systems and methods are not to be restricted except in light of the attached claims and their equivalents.

What is claimed is:

1. A method comprising:
in a system comprising a processor:
determining an optimal global alignment for an input sequence pair by:
generating a score matrix for the input sequence pair;
partitioning the score matrix into multiple sectors;
computing cell content for each cell in the score matrix, where the cell content of a cell comprises an optimal alignment score corresponding to the cell and a directional indication, and while computing the cell content:
selectively retaining the computed cell content of a predetermined set of cells in the score matrix;
obtaining a traceback path for the score matrix by:
iteratively determining a current sector and initial cell in the current sector and processing the current sector to determine a traceback path for the current sector until the upper left sector of the score matrix is processed as the current sector; and
obtaining the optimal global alignment for the input sequence pair from the traceback path of the score matrix.

2. The method of claim 1, where processing the current sector comprises:
executing a predetermined number of instructions to process the current sector.

3. The method of claim 2, where executing comprises:
when the traceback path for the current sector is determined prior to executing the predetermined number of instructions:
executing dummy instructions until the predetermined number of instructions has been executed.

4. The method of claim 2, where executing comprises:
executing the predetermined number of instructions equal to a worst case number of instructions to determine the traceback path for the current sector.

5. The method of claim 1, comprising:
in a system comprising a single instruction multiple data (SIMD) processor:
determining, in parallel, the optimal global alignment for multiple input sequence pairs.

6. The method of claim 1, where selectively retaining comprises:
retaining the computed cell content of cells in the score matrix corresponding to upper or left boundary cells of the multiple sectors.

7. The method of claim 6, where selectively retaining further comprises:
discarding the computed cell content of cells in the score matrix that do not correspond to upper or left boundary cells of the multiple sectors.

8. The method of claim 6, where processing the current sector comprises:
retrieving the retained cell contents for the upper and left boundary cells of the current sector;
recomputing cell contents of the current sector using the retrieved cell contents; and
determining the traceback path of the current sector using the recomputed cell contents of the current sector.

9. The method of claim 1, where iteratively determining and processing the current sector comprises:
when the current sector is not the upper left sector of the score matrix:
determining a next sector and initial cell in the next sector according to the directional indication of a last cell in the traceback path of the current sector.

10. The method of claim 1, where iteratively determining and processing the current sector comprises:
processing a predetermined number of sectors in the score matrix.

11. The method of claim 10, where processing the predetermined number of sectors in the score matrix comprises:
when the traceback path for the score matrix is obtained prior to processing the predetermined number of sectors:
processing a remaining number of sectors by executing dummy instructions until the predetermined number of sectors have been processed.

12. A system comprising:
alignment circuitry operable to:
determine an optimal global alignment for an input sequence pair by:
generating a score matrix for the input sequence pair;
partitioning the score matrix into multiple sectors;
computing cell content for each cell in the score matrix, where the cell content of a cell comprises an optimal alignment score corresponding to the cell and a directional indication, and while computing the cell content:
selectively retaining the computed cell content of a predetermined set of cells in the score matrix;
obtaining a traceback path for the score matrix by:
iteratively determining a current sector and initial cell in the current sector and processing the current sector to determine a traceback path for the current sector until the upper left sector of the score matrix is processed as the current sector; and
obtaining the optimal global alignment for the input sequence pair from the traceback path of the score matrix.

13. The system of claim 12, where the alignment circuitry is operable to process the current sector by:
executing a predetermined number of instructions to process the current sector.

14. The system of claim 13, where the alignment circuitry is operable to execute the predetermined number of instructions to process the current sector by:
when the traceback path for the current sector is determined prior to executing the predetermined number of instructions:
executing dummy instructions until the predetermined number of instructions has been executed.

15. The system of claim 13, where the predetermined number of instructions is equal to a worst case number of instructions to determine the traceback path for the current sector.

16. The system of claim 12, where the alignment circuitry comprises a single instruction multiple data (SIMD) processor operable to determine, in parallel, the optimal global alignment for multiple input sequence pairs.

17. The system of claim 12, where the alignment circuitry is operable to selectively retain the computed cell content by:
retaining the computed cell content of cells in the score matrix corresponding to upper or left boundary cells of the multiple sectors.

18. The system of claim 17, where the alignment circuitry is further operable to selectively retain the computed cell content by:
discarding the computed cell content of cells in the score matrix that do not correspond to upper or left boundary cells of the multiple sectors.

19. The system of claim 17, where the alignment circuitry is operable to process the current sector by:
retrieving the retained cell contents for the upper and left boundary cells of the current sector;
recomputing cell contents of the current sector using the retrieved cell contents; and
determining the traceback path of the current sector using the recomputed cell contents of the current sector.

20. The system of claim 12, where the alignment circuitry is operable to iteratively determine and process the current sector by:
when the current sector is not the upper left sector of the score matrix:
determining a next sector and initial cell in the next sector according to the directional indication of a last cell in the traceback path of the current sector.

21. The system of claim 12, where the alignment circuitry is operable to iteratively determine and process the current sector by:
processing a predetermined number of sectors in the score matrix.

22. The system of claim 21, where the alignment circuitry is operable to process the predetermined number of sectors in the score matrix by:
when the traceback path for the score matrix is obtained prior to processing the predetermined number of sectors:
processing a remaining number of sectors by executing dummy instructions until the predetermined number of sectors have been processed.

23. A product comprising:
a non-transitory machine readable medium storing processor executable instructions, that when executed by a processor, causes the processor to:
determine an optimal global alignment for an input sequence pair by:
generating a score matrix for the input sequence pair;
partitioning the score matrix into multiple sectors;
computing cell content for each cell in the score matrix, where the cell content of a cell comprises an optimal alignment score corresponding to the cell and a directional indication, and while computing the cell content:
selectively retaining the computed cell content of a predetermined set of cells in the score matrix;
obtaining a traceback path for the score matrix by:
iteratively determining a current sector and initial cell in the current sector and processing the current sector to determine a traceback path for the current sector until the upper left sector of the score matrix is processed as the current sector; and
obtaining the optimal global alignment for the input sequence pair from the traceback path of the score matrix.

24. The product of claim 23, where the processor executable instructions cause the processor to process the current sector by:
executing a predetermined number of instructions to process the current sector.

25. The product of claim 24, where the processor executable instructions cause the processor to execute the predetermined number of instructions to process the current sector by:
when the traceback path for the current sector is determined prior to executing the predetermined number of instructions:
executing dummy instructions until the predetermined number of instructions has been executed.

26. The product of claim 24, where the predetermined number of instructions is equal to a worst case number of instructions to determine the traceback path for the current sector.

27. The product of claim 23, where the processor comprises a single instruction multiple data (SIMD) processor; and
where the processor executable instructions cause the SIMD processor to determine, in parallel, the optimal global alignment for multiple input sequence pairs.

28. The product of claim 23, where the processor executable instructions cause the processor to selectively retain the computed cell content by:
retaining the computed cell content of cells in the score matrix corresponding to upper or left boundary cells of the multiple sectors.

29. The product of claim 28, where the alignment circuitry is further operable to selectively retain the computed cell content by:
discarding the computed cell content of cells in the score matrix that do not correspond to upper or left boundary cells of the multiple sectors.

30. The product of claim 28, where the processor executable instructions cause the processor to process the current sector by:
retrieving the retained cell contents for the upper and left boundary cells of the current sector;
recomputing cell contents of the current sector using the retrieved cell contents; and
determining the traceback path of the current sector using the recomputed cell contents of the current sector.

31. The product of claim 23, where the processor executable instructions cause the processor to iteratively determine and process the current sector by:
when the current sector is not the upper left sector of the score matrix:
determining a next sector and initial cell in the next sector according to the directional indication of a last cell in the traceback path of the current sector.

32. The product of claim 23, where the processor executable instructions cause the processor to iteratively determine and process the current sector by:
processing a predetermined number of sectors in the score matrix.

33. The product of claim 32, where the processor executable instructions cause the processor to process the predetermined number of sectors in the score matrix by:
when the traceback path for the score matrix is obtained prior to processing the predetermined number of sectors:
processing a remaining number of sectors by executing dummy instructions until the predetermined number of sectors have been processed.
